(19) United States
(12) Patent Application Publication
(10) Pub. No.: US 2020/0195180 A1
(43) Pub. Date: Jun. 18, 2020

(54) HALL SENSOR BASED FIELD ORIENTED CONTROL SYSTEM FOR BRUSHLESS ELECTRIC MOTOR

(71) Applicant: Magna Closures Inc., Newmarket (CA)

(72) Inventors: Ke LI, Aurora (CA); Junchao Liu, Richmond Hill (CA)

(21) Appl. No.: 16/712,013

(22) Filed: Dec. 12, 2019

Related U.S. Application Data
(60) Provisional application No. 62/781,008, filed on Dec. 18, 2018.

(51) Int. Cl. H02P 21/18; H02P 21/00; H02P 25/03

(52) U.S. Cl. CPC H02P 21/18; H02P 25/03; H02P 21/50

(57) ABSTRACT

A control system and method for controlling a brushless electric motor of a power operated actuator of a closure panel of a vehicle are provided. The control system includes a vector control system coupled to the motor to receive an estimated position of a rotor of the motor and a target torque current based on an actual angular velocity of the rotor. The vector control system also determines an alpha stationary reference frame voltage and a beta stationary reference frame voltage based on the target torque current and phase currents from the brushless electric motor in response to a Hall sensor trigger. The vector control system maintains the alpha stationary reference frame voltage and a beta stationary reference frame voltage and outputs a pulse width modulation signals to the motor based on the alpha stationary reference frame voltage and the beta stationary reference frame voltage.

### CROSS-REFERENCE TO RELATED APPLICATIONS

This application claims the benefit of previously filed U.S. Provisional Patent Application No. 62/781,008, filed Dec. 18, 2018, the entire content of which is hereby incorporated by reference in its entirety.

### FIELD

The present disclosure relates generally to a motor control system for an automotive power operated actuator and, more particularly to a torque current limiting vector control system for a brushless motor used in the power operated actuator. The present disclosure also relates to a method of operating the control system.

### BACKGROUND

This section provides background information related to the present disclosure which is not necessarily prior art.

Window regulators and other power operated actuators are commonly found on motor vehicles. Such power operated actuators may be designed to meet stringent safety requirements and standards to ensure the safety of operators of the actuators. Specifically, for window regulators or power actuators used for vehicle closure members, the challenge is producing a motor control system that is capable of detecting and reacting quickly enough for pinch protection during a closing event. Consequently, accurate control of motor position can be advantageous. While sensors such as resolvers and encoders may be utilized to determine motor position, such sensors can add significant cost and complexity to the motor control system.

Accordingly, there remains a need for improved motor control systems used in power operated actuators and methods of operation thereof that overcome these shortcomings.

### SUMMARY

This section provides a general summary of the present disclosure and is not a comprehensive disclosure of its full scope or all of its features and advantages.

It is an object of the present disclosure to provide a motor control system and a method of operating the control system that address and overcome the above-noted shortcomings.

Accordingly, it is an aspect of the present disclosure to provide a control system for controlling a brushless electric motor of a power operated actuator of a closure panel of a vehicle. The control system includes a vector control system coupled to the brushless electric motor. The vector control system is configured to receive an estimated position of a rotor of the brushless electric motor and a target torque current based on an actual angular velocity of the rotor of the brushless electric motor. The vector control system is also configured to determine an alpha stationary reference frame voltage and a beta stationary reference frame voltage based on the target torque current and a first phase current and a second phase current and a third phase current from the brushless electric motor in response to a Hall sensor trigger based on a plurality of Hall sensor signals from a plurality of Hall sensors sensing a position of the rotor of the brushless electric motor. The vector control system is also configured to maintain the alpha stationary reference frame voltage and a beta stationary reference frame voltage and output a first phase pulse width modulation signal and a second phase pulse width modulation signal and a third phase pulse width modulation signal to the brushless electric motor based on the alpha stationary reference frame voltage and the beta stationary reference frame voltage.

In one aspect, the alpha stationary reference frame voltage \hat{V}α and the beta stationary reference frame voltage \hat{V}β is maintained until a subsequent Hall sensor trigger.

In one aspect, the alpha stationary reference frame voltage \hat{V}α and the beta stationary reference frame voltage \hat{V}β is maintained as a function of an estimated position θ of the rotor.

In one aspect, the system includes a position determining system coupled to the vector control system and the brushless electric motor and configured to: receive the plurality of Hall sensor signals, count a plurality of Hall pulses of the plurality of Hall sensor signals and determine a delta time between each of the plurality Hall pulses, and determine the actual angular velocity ω of the rotor of the brushless electric motor based on the delta time of a quantity of Hall pulses counted.

In one aspect, the position determining system is further configured to determine the estimated position θ of the rotor of the brushless electric motor based on an angular position offset corresponding to the delta time between each of the plurality Hall pulses and added to a sector angle of one of the plurality of Hall sensors from which one of the plurality of Hall pulses was last received.

In one aspect, the position determining system includes: a pulse counter unit configured to receive the plurality of Hall sensor signals and count the plurality of the Hall pulses of the plurality of Hall sensor signals and determine the delta time between each of the plurality Hall pulses and output the quantity of Hall pulses counted and the delta time; and a velocity conversion unit having a timer delta input and configured to receive the delta time and determine the actual angular velocity ω of the rotor of the brushless electric motor based on the delta time of the quantity of Hall pulses counted.

In one aspect, the position determining system further includes a filter unit configured to filter the actual angular velocity ω.

In one aspect, the position determining system further includes a multiplier unit having a first multiplier input being the delta time and a second multiplier input being the actual angular velocity ω and a multiplier output and configured to multiply the delta time and the actual angular velocity ω and output an angular position offset at the multiplier output.

In one aspect, the position determining system further includes: a Hall sector determination unit configured to receive the plurality of Hall sensor signals and determine and output the one of a plurality of Hall sectors in which the rotor of the brushless electric motor is currently located based on the one of the plurality of Hall pulses last received; a base angle unit configured to receive the one of the plurality of Hall sectors and output a sector angle corresponding to the one of the plurality of Hall sectors in which the rotor of the brushless electric motor is currently located; and an adder unit having a first adder input being sector angle and a second adder input being the angular position offset and an adder output and configured to add the sector angle and the angular position offset and output the estimated position θ of the rotor of the brushless electric motor at the adder output.

In one aspect, the vector control system comprises: a first proportional-integral control unit configured to receive the target torque current based on the actual angular velocity ω of the brushless electric motor and a torque current drawn and output a torque voltage command Vq and a flux linkage voltage command Vd using the torque current and the torque current drawn; an inverse Park transformation unit coupled to the first proportional-integral control unit and configured to receive an actual angular position θ of the brushless electric motor and transform the torque voltage command and the flux linkage voltage command to the alpha stationary reference frame voltage and the beta stationary reference frame voltage an inverse Park transformation; a switching states vector pulse width modulation unit coupled to the inverse Park transformation unit and to the brushless electric motor and configured to determine and output a first phase pulse width modulation signal PWMa and a second phase pulse width modulation signal PWMb and a third phase pulse width modulation signal PWMc to the brushless electric motor; a Clarke transformation unit coupled to the brushless electric motor and configured to receive the first phase current Ia and the second phase current Ib and the third phase current Ic from the brushless electric motor and determine and output an alpha stationary reference frame current and a beta stationary reference frame current using a Clarke transformation; a Park transformation unit coupled to the Clarke transformation unit and configured to receive the alpha stationary reference frame current and the beta stationary reference frame current and determine and output the torque current drawn and a field flux linkage current drawn using a Park transformation; and a second proportional-integral control unit coupled to the inverse Park transformation unit and the Park transformation unit and configured to receive a reference flux linkage current and the flux linkage current drawn and determine and output the flux linkage voltage command to the inverse Park transformation unit.

According to another aspect of the disclosure, a method of controlling a brushless electric motor using a control system including a vector control system and a position determining system is provided. The method includes the step of sampling a first phase current and a second phase current and a third phase current from the brushless electric motor using the vector control system. The method continues by receiving a plurality of Hall sensor signals from a plurality of Hall sensors sensing a position of a rotor of the brushless electric motor using the position determining system. The next step of the method is determining whether an edge of a plurality of Hall sensor signals is detected. The method then proceeds by setting a stored flux linkage voltage command and one of a stored torque voltage command and a stored start-up calculated torque voltage command with the vector control system in response to determining the edge of the plurality of Hall sensor signals is not detected. The method then includes the step of outputting a first phase pulse width modulation signal and a second phase pulse width modulation signal and a third phase pulse width modulation signal to the brushless electric motor using a switching states vector pulse width modulation unit using the stored flux linkage voltage command and the stored torque voltage command updated based on the position of the rotor of the brushless electric motor. Next, the method includes the step of rotating the brushless electric motor due to the first phase pulse width modulation signal and the second phase pulse width modulation signal and the third phase pulse width modulation signal.

In one aspect, the method includes the step of updating the stored flux linkage voltage command and the stored torque voltage command with the vector control system based on sampling the first phase current Ia and the second phase current Ib and the third phase current Ic in response to determining a subsequent edge of the plurality of Hall sensor signals is detected.

In one aspect, the step of updating the flux linkage voltage command and the stored torque voltage command includes entering a first interrupt subroutine to update and store the stored flux linkage voltage command and the stored torque voltage command using the vector control system in response to determining the edge of the plurality of Hall sensor signals is detected; returning to the step of sampling the first phase current Ia and the second phase current Ib and the third phase current Ic from the brushless electric motor; and updating the stored flux linkage voltage command and the stored torque voltage command using the sampled the first phase current Ia and the second phase current Ib and the third phase current Ic.

In one aspect, the method further includes the steps of: determining whether the rotor of the brushless electric motor is stopped or rotating at less than a predetermined angular velocity based on the plurality of Hall sensor signals; assuming a position of the rotor being at an assumed position in response to the rotor of the brushless electric motor being stopped or rotating at less than a predetermined angular velocity; and updating the stored torque voltage command based on the assumed position and a plurality of predetermined application specific system parameters to minimize stresses on the brushless electric motor and provide a maximized torque force.

In one aspect, the step of updating the stored torque voltage command based on the assumed position and the plurality of predetermined application specific system parameters includes the step of calculating the stored torque voltage command as: Vq=cosine(((360/(HSQ*2))/2)*Vq, wherein Vq is the stored torque voltage command and HSQ is a quantity of the plurality of Hall sensors.

In one aspect, the step of determining whether an edge of a plurality of Hall sensor signals is detected includes the step of determining whether an edge of a plurality of Hall sensor signals is detected in response to calculating the torque voltage command based on the assumed position and the plurality of predetermined application specific system parameters.

In one aspect, the step of determining whether an edge of a plurality of Hall sensor signals is detected is further defined as determining whether the edge of a plurality of Hall sensor signals is detected in response to the rotor of the brushless electric motor not being stopped and not rotating at less than a predetermined speed.

In one aspect, the step of entering the first interrupt subroutine to obtain and store the stored flux linkage voltage command and the stored torque voltage command using the vector control system to minimize a field flux linkage current and maximize a torque current in response to determining the edge of the plurality of Hall sensor signals is detected includes: calculating the stored flux linkage voltage command and the stored torque voltage command using the vector control system based on the position of the rotor when the edge of the plurality of Hall sensor signals is detected to minimize a field flux linkage current and maximize the torque current; and updating the stored flux linkage voltage command and the stored torque voltage command in a memory to be used by the switching states vector pulse width modulation unit.

In one aspect, the method further includes the steps of: determining a torque current based on the first phase current Ia and the second phase current Ib and the third phase current Ic from the brushless electric motor using the vector control system; determining an actual angular velocity ω of the rotor of the brushless electric motor based on the plurality of Hall sensor signals using a position determining system; determining whether the torque current is increasing and the actual angular velocity ω of the rotor of the brushless electric motor is decreasing; and determining there is a pinch event in response to the torque current increasing and the actual angular velocity ω of the rotor of the brushless electric motor decreasing.

In one aspect, the step of determining the actual angular velocity of the rotor of the brushless electric motor based on the plurality of Hall sensor signals using the position determining system includes the steps of: receiving the plurality of Hall sensor signals using the position determining system; counting the plurality of Hall pulses of the plurality of Hall sensor signals and determining a delta time between each of the plurality Hall pulses; and determining the actual angular velocity ω of the rotor of the brushless electric motor based on the delta time of a quantity of Hall pulses counted.

In one aspect the method further includes the step of determining an actual angular position θ of the rotor of the brushless electric motor based on an angular position offset corresponding to the delta time between each of the plurality Hall pulses and added to a sector angle of one of the plurality of Hall sensors from which one of the plurality of Hall pulses was last received.

In one aspect, the method further includes the steps of: determining whether the edge of a plurality of Hall sensor signals is detected; assuming the position of the rotor being at an assumed position in response to determining the edge of the plurality of Hall sensor signals is not detected; and updating the stored torque voltage command based on the assumed position as a negative stored torque voltage command; outputting the first phase pulse width modulation signal PWMa and the second phase pulse width modulation signal PWMb and the third phase pulse width modulation signal PWMc to the brushless electric motor using the switching states vector pulse width modulation unit using the negative stored flux linkage voltage command and the stored torque voltage command updated based on the position θ of the rotor of the brushless electric motor; rotating the brushless electric motor due to the first phase pulse width modulation signal PWMa and the second phase pulse width modulation signal PWMb and the third phase pulse width modulation signal PWMc; entering a second interrupt subroutine to update and store the stored flux linkage voltage command and the negative stored torque voltage command using the vector control system in response to determining the edge of the plurality of Hall sensor signals is detected; and returning to the step of sampling the first phase current Ia and the second phase current Ib and the third phase current Ic from the brushless electric motor in response to outputting the first phase pulse width modulation signal PWMa and the second phase pulse width modulation signal PWMb and the third phase pulse width modulation signal PWMc to the brushless electric motor using the switching states vector pulse width modulation unit.

In one aspect, the step of updating the stored torque voltage command based on the assumed position as a negative stored torque voltage command includes the step of calculating the negative stored torque voltage command as: Vq=−cosine(((360/(HSQ*2))/2)*Vq, wherein Vq is the stored torque voltage command and HSQ is a quantity of the plurality of Hall sensors.

In one aspect, the method further includes the step of setting a reverse speed in response to determining there is the pinch event.

In one aspect, the step of outputting the first phase pulse width modulation signal PWMa and the second phase pulse width modulation signal PWMb and the third phase pulse width modulation signal PWMc to the brushless electric motor using the switching states vector pulse width modulation unit using the stored flux linkage voltage command and the negative stored torque voltage command updated based on the position θ of the rotor of the brushless electric motor includes the steps of: triggering a Clarke transformation unit to determine and output an alpha stationary reference frame current and a beta stationary reference frame current using a Clarke transformation based on the first phase current Ia and the second phase current Ib and the third phase current Ic from the brushless electric motor; and triggering a Park transformation unit coupled to the Clarke transformation unit to determine and output the torque current drawn and a field flux linkage current drawn using a Park transformation based on the alpha stationary reference frame current and the beta stationary reference frame current.

In one aspect, the method further includes the step of triggering an inverse Park transformation unit coupled to a first proportional-integral control unit to transform the torque voltage command and the flux linkage voltage command to the alpha stationary reference frame voltage and the beta stationary reference frame voltage using an inverse Park transformation based on an actual angular position θ of the brushless electric motor

According to yet another aspect of the disclosure, a control system for controlling a brushless electric motor of a power operated actuator of a closure panel of a vehicle is provided. The control system includes a vector control system coupled to the brushless electric motor. The vector control system is configured to receive an estimated position of a rotor of the brushless electric motor and a target torque current based on an actual angular velocity of the rotor of the brushless electric motor. The vector control system is also configured to determine an alpha stationary reference frame voltage and a beta stationary reference frame voltage based on the torque current and a first phase current and a second phase current and a third phase current from the brushless electric motor detected in response to a Hall sensor trigger based on a plurality of Hall sensor signals from a plurality of Hall sensors sensing a position of the rotor of the brushless electric motor. In addition, the vector control system is configured to maintain the alpha stationary reference frame voltage and a beta stationary reference frame voltage as a function of an actual angular position of the brushless electric motor until a subsequent Hall sensor trigger is detected. The vector control system is also configured to output a first phase pulse width modulation signal and a second phase pulse width modulation signal and a third phase pulse width modulation signal to the brushless electric motor based on the alpha stationary reference frame voltage and the beta stationary reference frame voltage.

According to a further aspect of the present disclosure, there is provided a control system for controlling a brushless electric motor of a power operated actuator, the brushless electric motor having a rotor and at least one Hall sensor sensing a position of the rotor, the control system including a vector control system coupled to the brushless electric motor and configured to calculate a quadrature current component and a flux current component in response to the at least one Hall sensor sensing a position of the rotor of the brushless electric motor, and control a pulse width modulation signal supplied to the brushless electric motor based on the quadrature current component and a flux current component. The triggering of the calculation of the quadrature current component and the flux current component may be performed upon detecting the exact position of the rotor, for example using the Hall sensors signal.

According to a further aspect of the present disclosure there is provided a method of controlling a brushless electric motor using a control system including a vector control system and a position determining system, including the steps of calculating a quadrature current component and a flux current component in response to the position determining system sensing a position of the rotor of the brushless electric motor, and controlling a pulse width modulation signal supplied to the brushless electric motor based on the quadrature current component and a flux current component. The triggering of the calculating of the quadrature current component and the flux current component may be performed upon detecting the exact position of the rotor, for example using the Hall sensors signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a motor vehicle including moveable windows and closure panels, in accordance with an illustrative embodiment;

FIG. 2 is a side view of a closure panel having a moveable window and window regulator unit in accordance with an illustrative embodiment;

FIG. 3 is a side cross-sectional view of the window regulator actuator unit of FIG. 4, in accordance with an illustrative embodiment;

FIG. 4 is a diagrammatic view of a brushless motor of the window regulator actuator unit of FIG. 3, in accordance with an illustrative embodiment;

FIG. 5 is a block diagram of a control system for controlling the brushless motor of FIG. 4, in accordance with an illustrative embodiment;

FIG. 6 is a schematic representation of operating zones of the brushless DC electric motor according to aspects of the disclosure;

FIG. 7 shows plots of phase shifted 3-axis stator system electrical quantities associated to different driving modes of the brushless electric motor according to aspects of the disclosure;

FIG. 8 and FIG. 9 show opposite sides of a printed circuit board having a control circuit for controlling the brushless motor of FIG. 4, in accordance with an illustrative embodiment;

FIG. 10 illustrates a stator current vector decomposed into a 2-axis reference frame quadrature current and flux current components, in accordance with an illustrative embodiment;

FIG. 11 is a diagrammatic view of the stator and rotor of a brushless motor illustrating the rotor magnetic field and the stator magnetic field, and quadrature and stator forces acting on the rotor, in accordance with an illustrative embodiment;

FIG. 12 is a 3-axis representation of the 2-axis transformed stator current vector of FIG. 10, illustrating the delta between the stator current vector and the quadrature axis of the rotor, in accordance with an illustrative embodiment;

FIGS. 13A-13B illustrates a motor controller architecture according to aspects of the disclosure;

FIG. 14 is a block diagram of a control system for controlling the brushless electric motor shown in FIG. 4 of the power operated actuator in FIG. 3 of a closure panel of a vehicle according to aspects of the disclosure;

FIG. 15 is a block diagram of the control system of FIG. 14, illustrating the resultant changes in quadrature and flux current components in accordance with aspects of the disclosure;

FIG. 16 illustrates example Hall sensor signals according to aspects of the disclosure; and

FIGS. 17-21 illustrate steps of a method of controlling a brushless electric motor using a control system including a vector control system and a position detection system according to aspects of the disclosure.

### DETAILED DESCRIPTION

The expression “closure panel” will be used, in the following description and the accompanying claims, to generally indicate any element movable between an open position and a closed position, respectively opening and closing an access to an inner compartment of a motor vehicle, therefore including, boot, doors, liftgates, sliding doors, rear hatches, bonnet lid or other closed compartments, windows, sunroofs, in addition to the side doors of a motor vehicle.

In general, the present disclosure relates to a motor control system of the type well-suited for use in many electric motor applications. The motor control system and associated methods of operation of this disclosure will be described in conjunction with one or more example embodiments. However, the specific example embodiments disclosed are merely provided to describe the inventive concepts, features, advantages and objectives with sufficient clarity to permit those skilled in this art to understand and practice the disclosure. Specifically, the example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

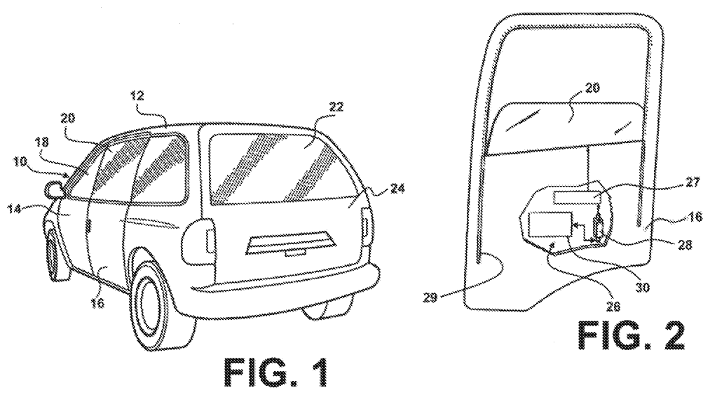

Now referring initially to FIG. 1 of the drawings, an example of a motor vehicle 10 is shown having a vehicle body 12, a hinged front door 14 and a sliding rear door 16. Front door 14 is equipped with a window 18 which is moveable between closed and open positions via a power-operated window lift system. Similarly, rear door 16 is equipped with a window 20 which is moveable between closed and open positions via a power-operated window lift system. While the present disclosure will hereinafter be specifically directed to describing the window lift system associated with rear sliding door 16, those skilled in the art will recognize and appreciate that similar arrangements to that described herein can be adapted for use with front door 14 and/or a window 22 associated with a hinged liftgate 24, as well as any other type of closure panel, and as well as other vehicle power actuators, such as for power release, power lock in vehicle door latches, as well as for cinching actuators, and the like.

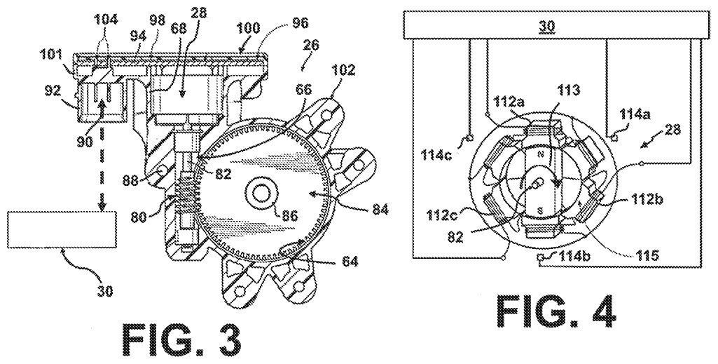

As best shown in FIG. 2, an automotive power actuator unit 26 of the power-operated window lift system for the motor vehicle 10, in particular a window regulator is provided. The power actuator unit 26 is operable for driving the slider pane or window 20 of FIG. 1 through a coupling 27, between open and closed positions with respect to a supporting frame 29, fixed to the door 16. The power operated actuator 10 includes an electric motor 28, and a controller unit 30, electrically coupled to the electric motor 28, and including (as will be discussed in the following) suitable hardware and/or software to control the operation of the electric motor 28.

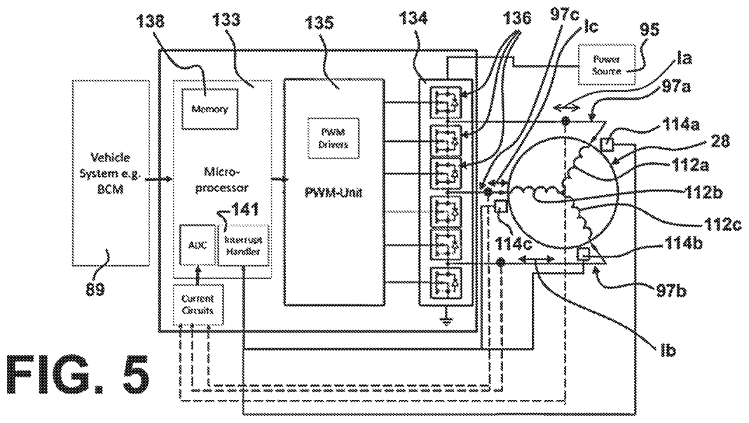

Now referring to FIG. 3, there is illustrated an example of the power actuator unit 26. In accordance with an illustrative example, powered operated actuator unit 26 may be a powered actuator unit having a brushless direct current (DC) electric motor. FIG. 3 more specifically illustrates powered actuator unit 26 including a drive housing 60 for the brushless DC electric motor 28. Drive housing 60 defines a gear chamber 64, a motor shaft chamber 66 communicating with gear chamber 64, and a motor mounting chamber 68 communicating with shaft chamber 66. A worm 80 fixed to motor shaft 82 is meshed with a large gear drive gear 84 that is rotatably supported in gear chamber 64. Rotation of the large gear 84 includes an output shaft 86 operably connected to a drum (not shown) to control rotation of the drum associated with a cable-pulley drive mechanism when large gear 84 rotates. The electric motor 28, is mounted in mounting chamber 68 and is operable to control the amount and direction of rotation of motor shaft 82. Housing 60 includes several apertured mounting lugs 88 for securing powered actuator unit 26 to door 16. Control signals, provided from the controller unit 30, as will be described herein below, are supplied to powered actuator unit 26. Illustratively, the controller unit 30 is shown to be remote from the brushless DC electric motor 28 and electrically connected therewith via a wiring harness 90 having one end secured in a plug in electrical connector 92 extending from mounting chamber 68. Control signals may alternatively be provided from a locally-located controller unit 30, for example as mounted to a printed circuit board (PCB) 94 disposed within an enclosure chamber 98.

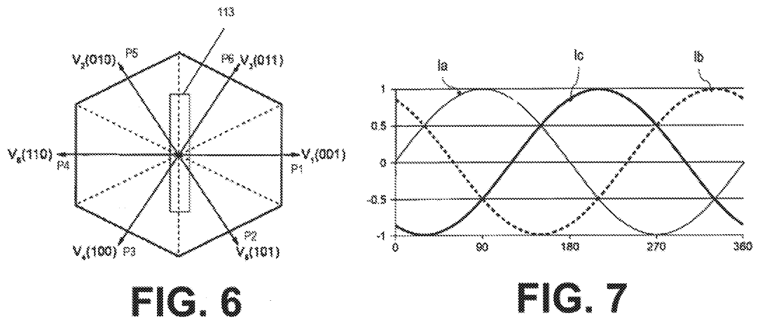

As schematically shown in FIG. 4, the brushless DC (Direct Current) electric motor 28 or simply brushless electric motor 28 or motor 28 includes a number of stator windings 112a, 112b, 112c (three in the example, connected in a star configuration), and a rotor 113, having two poles (‘N’ or North and CS' or South) in the example, which is operable to rotate with respect to the stator windings 112a, 112b, 112c. The rotation of the rotor 113, which may be connected to an output shaft (e.g., motor shaft 82), which is in operable communication with the coupling 27, such as worm 80, large gear drive gear 84, and output shaft 86, or other mechanism for imparting a movement to the closure panel, such as window 20 as illustrated in FIG. 2.

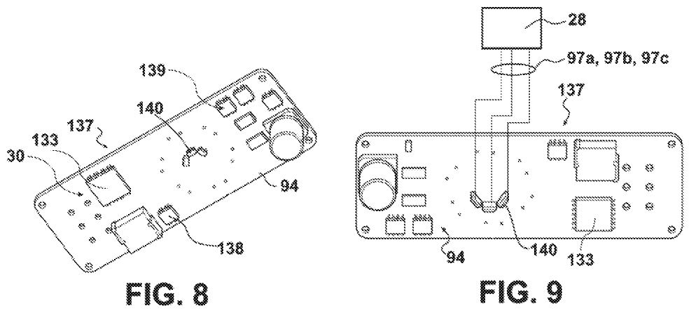

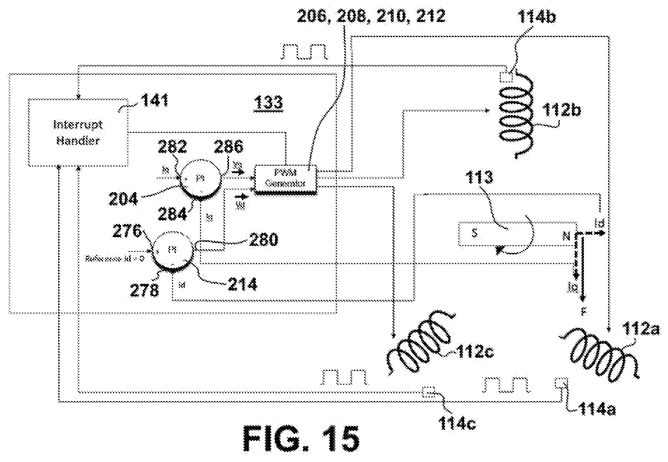

Now referring to FIG. 5 in addition to FIG. 4, control of the brushless electric motor 28 envisages electrical periodical switching of the generated currents Ia, Ib, Ic flowing in the stator windings 112a, 112b, 112c as energized by a DC power source e.g. Voltage Source 95 in electrical communication with the windings 112a, 112b, 112c, in order to maintain the rotation of the rotor 113 via the resulting magnetic interaction. For example, the controller unit 30 of the power actuator 10 includes a microprocessor 133, a three-phase inverter 134, and a PWM (Pulse Width Modulation) unit 135, coupled to the phase stator windings 112a, 112b, 112c. The microprocessor 133 may be configured to control the three-phase inverter 134 and a PWM (Pulse Width Modulation) unit 135 for controlling a pulse width modulation signal, for example the electrical periodical switching of the generated currents Ia, Ib, Ic flowing in the stator windings 112a, 112b, 112c, supplied to the brushless electric motor 28. In a known manner, here not discussed in detail, the three-phase inverter 134 includes three pairs of power transistor switches 136 for each stator winding 112a, 112b, 112c, which are controlled by the PWM unit 135 so as to drive the respective phase voltages either at a high (ON) or a low (OFF) value, in order to control the average value of related voltages/currents energizing the stator windings 112a, 112b, 112c. When the stator windings 112a, 112b, 112c are energized in a sequential order and magnitude, as determined by the microprocessor 133 controlling the PWM unit 135, a moving magnetic flux 99 is generated which shifts clockwise or counterclockwise (see FIG. 11). This moving magnetic flux 99 interacts with the magnetic flux 141 generated by the permanent magnetic rotor 113 to cause the rotor 113 to rotate. The rotational torque acting on the rotor 113 will ultimately impart a movement of the window 20 due to rotation of the shaft 82 and further connected components for driving movement of the window 20.

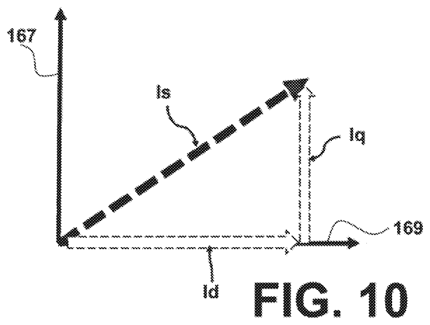

Now referring to FIGS. 4, 5 and 6, the control action requires knowledge of the position of the rotor 113 during its rotation to control the energizing voltage/current pattern to be applied to the windings 112a, 112b, 112c, also known as commutation. Accordingly, Hall sensors, or other kinds of position sensors, shown schematically as 114a, 114b, 114c, are circumferentially arranged with respect to the stator windings 112a, 112b, 112c (e.g., with an angular distance of 120° of separation between them, which in this example is the same angular spacing of the stator windings), in order to detect the position of the rotor 113, and electrically communicate the detected signals to the microprocessor 133 via the electrical lines 97a, 97b, 97c. For example, using three on/off Hall position sensors 114a, 114b, 114c, the magnetic position of the rotor 113 may be detected for six different radial zones, and in particular a precise position of the rotor 113, as schematically shown in FIG. 6 (where the different codes corresponding to the outputs provided by the position sensors 114a, 114b, 114c are shown for each zone). Other number of Hall position sensors may be provided. The commutation sequence is determined by the microprocessor 133 based on the relative positions of stator 115 and rotor 113, as measured by the either Hall-effect position sensors 114a, 114b, 114c or a magnitude of the back electromagnetic force (EMF) generated as the rotor 113 rotates as part of a sensor-less position detection technique.

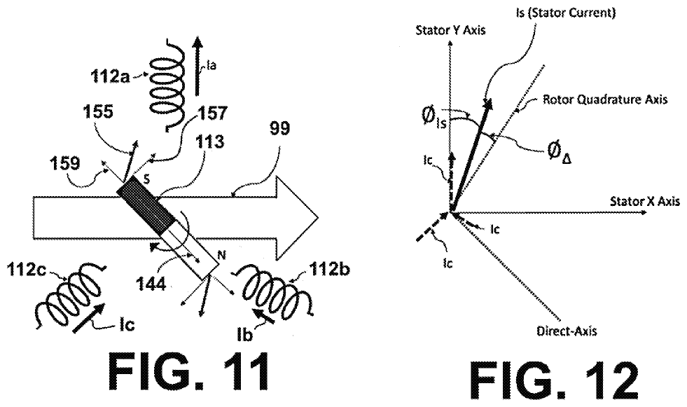

Now referring to FIG. 7 in addition to FIG. 6, control of the brushless electric motor 28 may be implemented in a sinusoidal drive mode, whereby the brushless electric motor 28 is supplied by three-phase pulse width modulation (PWM) voltages modulated to obtain phase currents Ia, Ib, Ic of a sinusoidal shape in the stator windings 112a, 112b, 112c, or coils, as schematically shown. With this sinusoidal commutation, all three electrical lines 97a, 97b, 97c, connected with the stator windings 112a, 112b, 112c and the PWM Unit 135, are permanently energized with sinusoidal currents Ia, Ib, Ic, that are 120 degrees out of phase with each other. For example, as shown in FIG. 7, the peaks of sinusoidal wave of currents Ia, Ic, and Ib are disposed at 90, 210, and 330 degrees, respectively. The resulting effect of the supplied current through the stator windings 112a, 112b, 112c is the generating of a North/South magnetic field 99 that rotates inside the motor stator 115 as the currents Ia, Ib, Ic are varied. The commutation process of switching the current flowing through the stator windings 112a, 112b, 112c, is calculated by the microprocessor 133 controlling the PWM unit 135 (MOSFETs 136).

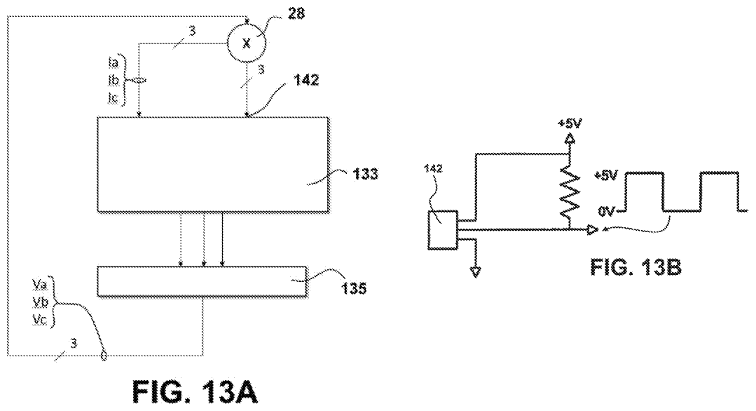

Now referring to FIGS. 8 and 9, in addition to FIG. 3, there is illustratively shown a controller arrangement 137 embodying the controller unit 30. Controller arrangement 137 is shown to generally include the printed circuit board (PCB) 94 disposed within enclosure chamber 98 upon installation of enclosure cover plate 100 onto enclosure section 101 of actuator housing 102. PCB 94 is shown to include various electrical or electronic components for controlling operation of powered actuator unit 10. Connector ports 103 are formed in PCB 94 and are configured and arranged to receive connector terminals 104 associated with a plug-in electrical connector 90 provided in connector section 92 of housing 102. The electronics mounted to the PCB 94 and electrically interconnected with one another may include hardware and software components such as a microcontroller 133, such as microprocessor 133, and memory modules, such as a memory chip 138, for storing instructions and algorithms (e.g., code) for execution by the microcontroller 133 of the motor control methods and techniques as described herein. While memory chip 138 is shown as separate, the memory module 138 could instead be part of the microcontroller, as shown in FIG. 5. Other components such as resistors, inductors, and capacitors and other signal conditioning/supporting components for operating the microcontroller 133 and memory modules 138 to control the motor 28 are provided. For example, instructions and code stored on the memory module 138 may also be related to various system modules, for example application programming interfaces (API) modules, drive API, digital input output API, Diagnostic API, Communication API, and communication drivers for LIN communications and CAN bus communications with the BCM 89 or other vehicle system. While modules may be described as being loaded into a memory 138, it is understood that the modules could be implemented in hardware and/or software. Also mounted to the PCB 94 may be FET hardware such as an H Bridge FET 139 (Field Effect Transistors), such as the power transistor switches 136 forming the inverter 134, and software loaded into the memory 138 related to such FETs 139, such as FET APIs.

The instructions and algorithms (e.g. code) for execution by the microcontroller 133 of the motor control methods and techniques as described herein may relate to the control of the H Bridge FET 139 (including Field Effect Transistors, such as power transistor switches 136) to provide coordinated power (e.g. sinusoidal voltages to generate currents Ia, Ib, Ic) to the motor 28, e.g. FETS 139 controlled as load switches to connect or disconnect a source of electrical energy 95 (voltage/current) as controlled by the microprocessor 133 or a FET driver to control the motor 28 in a manner as will be illustratively described below. Illustratively, the microprocessor 133 is electrically directly or indirectly connected to the H Bridge FET 139 for control thereof (e.g. for controlling of FET switching rate). The H Bridge FET 139 is shown as illustratively connected to the motor 28 via the three electrical lines 97a, 97b, 97c which are connected to connector pins 140 mounted to the printed circuit board 94. Sensed current signals as well as back EMF voltage signals generated by the rotation of the rotor 113 may also be illustratively received by the microprocessor 133 through the same electrical lines 97a, 97b, 97c. Additional connector pins (not shown) may be provided and be in electrical communication with Hall sensors 114a, 114b, 114c for receiving position signals of the rotor 113. While controller unit 100 is illustrated as being embodiment in the powered actuator unit 26 for a window regulator, it is understood it may be integrated into another system, such as powered door opening actuator for controlling the closing or opening of door 14, 16, 24, or within a separate door control module mounted to the door 14, 16, 24 which may be provided with an internal printed circuit board, such as PCB, microprocessor, memory, and FETs, for example. Other motor control systems may be controlled by the methods and manners described herein.

The controller unit 30 is configured to implement a field oriented control method or algorithm as stored in memory 138 as instructions and as executed by the microprocessor 133, for controlling the brushless electric motor 28. The controller unit 30 as described in detail herein below may be implemented in the controller arrangement 137 whereby the control algorithms may be represented as computer stored instructions and code stored on memory 138, and/or may be internal to the microprocessor 133 for controlling the motor 28 in accordance with the FOC control strategy as described herein. With Field Oriented Control (FOC) (or Vector Control) brushless motor techniques, as described herein, the torque and the flux can be controlled independently for improving the window regulator anti-pinch detection of an object, such as a finger, between the window 20 and the frame 29, and the response time to control the force moving the window 20, as well as improving motor starting, improving motor stopping, and improving motor reversing.

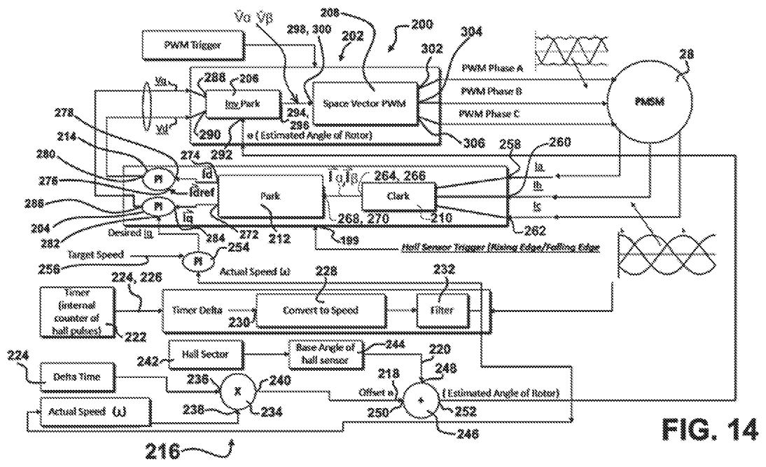

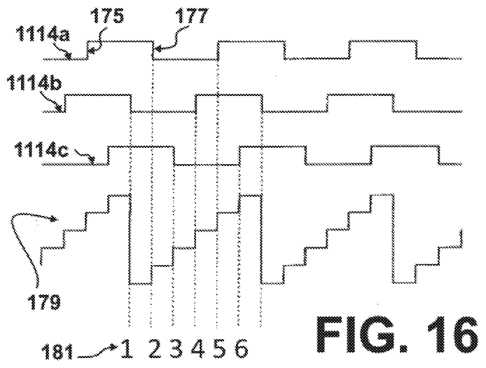

Referring now to FIG. 10, FIG. 11, and FIG. 12, the Field Oriented Control (FOC) (or Vector Control) brushless motor technique optimizes the torque generated by the rotor 113 over the angles of rotation of the rotor 113 relative to the windings 112a, 112b, 112c. The commutated currents Ia, Ib, Ic supplied to the windings 112a, 112b, 112c will generate a stator field 99 that is targeted to be orthogonal to the field of the rotor 113. The optimal direction of the net stator field force 155 to maximize torque of the rotor 113 rotation is illustrated as arrow 157 which acts to rotate the rotor 113. The sub-optimal direction of the net stator field force 155 is illustrated as arrow 159 which acts to outwardly pull on the rotor 113 and will generate no rotational torque on the rotor 113. When magnetic fields 99 and field 144 are parallel, the net stator field force 155 will only include the net stator field force 155 component as indicated by arrow 159, and therefore no torque is produced on the rotor 113. When magnetic fields 99 and field 144 are orthogonal, the net stator field force 155 will only include the net stator field force 155 component as indicated by arrow 157, and therefore maximum torque is produced on the rotor 113. Field Oriented Control (FOC) (or Vector Control) targets to eliminate (e.g., 0) the pulling force 159 to maximize the torque force 157.

In order to maximize the torque in such a manner, the currents Ia, Ib, Ic, and voltages applied to the windings 112a, 112b, 112c are controlled separately and as a function of the actual angular position θ of the rotor 113 relative to the windings 112a, 112b, 112c, in order to align the stator field 99 in an orthogonal orientation with the rotor magnetic field 144. The phase shifted resultant stator current Is as shown in FIG. 12 can be mathematically deconstructed into two components as illustrated in FIG. 10: a Quadrature current (Iq), or also referred to as torque current, which induces in the rotor 113 rotation according to the orthogonal force 157 acting on the rotor 113; and a Direct current (Id), or also referred to as flux current which induces the outward pulling force 159 on the rotor 113. The Field Oriented Control technique is concerned with adjusting these 2-axis domain components which are transformed using a transform function into the stator 3-axis domain as the three current signals Ia, Ib, Ic in order to reduce or eliminate the flux current Id to nil, leaving only the torque current Iq to generate the stator magnetic field 99 in quadrature with the rotor's quadrature axis as shown by arrow 157. In other words the control system may calculate the quadrature current component and the flux current component in a manner as described herein in order to generate a pulse wide modulated signal supplied to the motor. By adjusting the supplied motor currents and voltages with reference to the rotor's flux and quadrature axes, precise control of the rotor rotation results, such as decreases or increases in the rotor rotation can be precisely and quickly controlled since the torque current (Iq) can be adjusted based on the position θ of the rotor 113 which remains synchronized during rotation, which may be exactly determined by the use of the Hall sensor signals as will be described herein below. In other words the control system may calculate the quadrature current component (Iq) and the flux current component (Id) in response to the position of the rotor of the motor being determined by the Hall sensors, and that is without requiring an estimation of the position of the rotor, but rather an exact position of the rotor is used to trigger the calculation of the quadrature current component and the flux current component. FOC control can therefore provide faster dynamic response than compared with brushed motor control, for example those using trapezoidal commutated control since the torque current Iq is calculated based on the exact position of the rotor 113. Faster motor response times are desirable for window regulator applications, for example, to meet and surpass anti-pinch regulations (e.g. Torque current Iq can be precisely reduced and have an immediate effect on the rotation of the rotor 113 in order to reduce pinch forces). If higher regulation standards can be met, then safety concerns are mitigated and more advanced vehicle functions can be provided. Regarding anti-pinch benefits for a window regulator, since vector control allows for more precise control, as well as directly monitoring in torque current of the rotor 113, proposed herein is a FOC strategy that also allows for precise control and monitoring of a brushless motor during a pinch/obstacle event causing a reduction in motor speed (generally, it will be shown that torque is incrementally limited during a pinch/obstacle event). Additionally, improved motor control may be provided during normal operation of the motor 28.

Furthermore, in some power operated actuator systems, feedback control of the rotation of the rotor 113 is based on speed differences between the actual motor speed that occurs if there is a drop in motor speed and a target motor speed, and in response the voltage applied to the motor will be increased by the control system to increase the motor speed to meet the target motor speed. In typical brushless motor control systems, maintaining operating speed is a concern such as in brushless motor control for fans and pumps, however for anti-pinch/obstacle concerns feedback based speed control is not desirable. A torque based feedback control using FOC could also be implemented, where a desired torque output is required to be maintained for the application. These speed/torque objectives are typically in the context of brushless motors used for pump and fan control, where it is required to maintain the pump or fan at operating levels for maintaining system performance which is achieved when the motors are operated at constant outputs. Concerns such as an obstacle detection, or anti-pinch or strain on components are not present in these systems, as in the case of design of power operated actuators for closure panels. It hereby recognizes that FOC provides the precise torque adjustments and monitoring beneficial for anti-pinch/obstacle concerns. So, in some existing systems, as part of the control of the brushless electric motor 28, the existing control system would do the opposite of the system and method disclosed herein, and would rather increase the torque/speed to compensate for the decrease in the detected torque/speed during a motor speed decrease. However, during a pinch event, increasing the torque increases inertia in the system, increasing pinch forces and stopping times due to corresponding increases in inertia, and increases the strains and forces on the system components, opposite of what is desired for power operated actuators for closure panels.

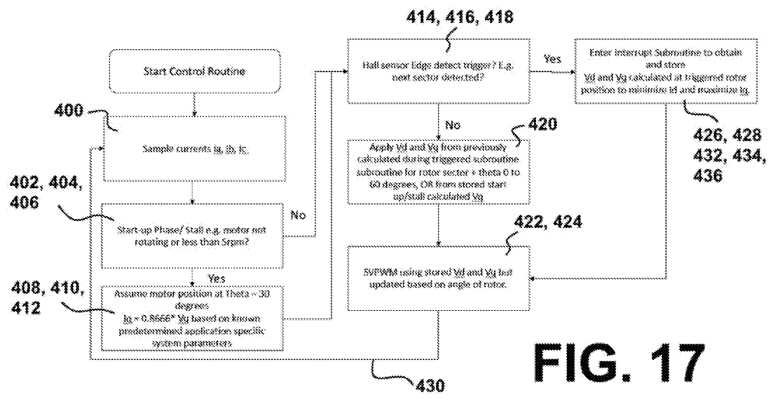

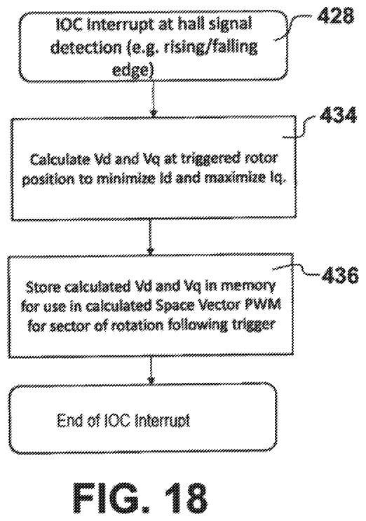

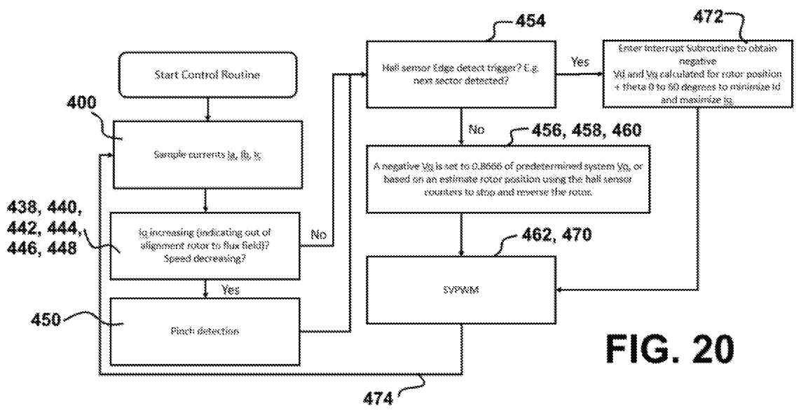

As best shown in FIGS. 13A-15, the control system 200 (FIG. 14) for controlling the brushless electric motor 28 of the power operated actuator 10 of a closure panel (e.g., window 20) of the vehicle 10 is provided. The control system 200 may be embodied in software as instructions stored in memory module 138 as executed by the microprocessor 133 and/or hardware components which may be mounted to PCB 94. The control system 200 includes a vector control system 202 configured to receive a target torque current \check{I}q based on an actual angular velocity ω of the brushless electric motor 28 (e.g., determined using Hall sensors 114a, 114b, 114c of FIG. 5, as described in more detail below) and a sensed first phase current Ia and a second phase current Ib and a third phase current Ic from the brushless electric motor 28 (e.g., currents flowing through windings/coils 112a, 112b, 112c, which may include current components induced as a result of the rotation of the rotor 113 in addition to currents supplied to the windings/coils 112a, 112b, 112c and sensed using an analog to digital converter, shown in FIG. 5). The vector control system 202 is also configured to determine an alpha stationary reference frame voltage [symbol] α and a beta stationary reference frame voltage based \hat{V}β based on the sensed first phase current Ia, second phase current Ib, and third phase current Ic in response to a Hall sensor trigger based on a plurality of Hall sensor signals from the plurality of Hall sensors 114a, 114b, 114c. For example, the Hall sensor signals can be received by an interrupt handler 141 (FIG. 5) at an interrupt port 142 (FIGS. 13A and 13B) of the microprocessor 133. So, the torque voltage command \hat{V}q and the flux linkage voltage command \hat{V}d are updated once the Hall sensor trigger is detected (at an interrupt time). An example trigger using three Hall sensor signals is shown in FIG. 16. Shown in FIG. 16 are Hall sensor signals 1114a, 1114b, 1114c, associated respectively with Hall sensors 114a, 114b, 114c, an example of a hall sensor rising edge 175 and falling edge 177, a controller trigger input 179 showing six triggers per motor revolution, and trigger no 181 per revolution.

Consequently, the torque FOC vector (Vd, Vq) is calculated based on the exact known position of the rotor 113 and moment to maximize torque applied to the rotor 113. This torque calculation is only done six times per revolution at each hall detection (e.g., if three Hall sensors 114a, 114b, 114c provided), compared to resolvers where calculations occur thousands of times per revolution. As a result, control system 200 uses the digital signals of the Hall sensors 114a, 114b, 114c to provide high accuracy of position θ of the rotor 113 which a resolver analog signal does not provide, and the FOC calculations are computationally less demanding resulting in quicker calculations and response times, a more efficient torque vector (Vd, Vq), as well as less expensive CPUs and processors.

The vector control system 202 maintains the alpha stationary reference frame voltage [symbol] α and the beta stationary reference frame voltage \hat{V}β. In addition, the vector control system 202 is configured to output a first phase pulse width modulation signal PWMa and a second phase pulse width modulation signal PWMb and a third phase pulse width modulation signal PWMc to the brushless electric motor 28 based on the alpha stationary reference frame voltage [symbol] α and the beta stationary reference frame voltage \hat{V}β. In more detail, the vector control system 202 includes a first proportional-integral control unit 204 configured to receive the target torque current \check{I}q based on the actual angular velocity ω of the brushless electric motor 28 and a torque current drawn [symbol] q and output a torque voltage command \hat{V}q using the target torque current \check{I}q the torque current drawn [symbol] q. An inverse Park transformation unit 206 is coupled to the first proportional-integral control unit 204 and is configured to receive an actual angular position θ of the brushless electric motor 28 and transform the torque voltage command \hat{V}q and a flux linkage voltage command \hat{V}d to an alpha stationary reference frame voltage \hat{V}α and a beta stationary reference frame voltage \hat{V}β using an inverse Park transformation. A switching states vector pulse width modulation unit 208 is coupled to the inverse Park transformation unit 206 and to the brushless electric motor 28 and is configured to convert the alpha stationary reference frame voltage \hat{V}α and a beta stationary reference frame voltage \hat{V}β to 3-phase stator reference signals and determine and output a first phase pulse width modulation signal PWMa and a second phase pulse width modulation signal PWMb and a third phase pulse width modulation signal PWMc to the brushless electric motor 28, as shown in the upper right portion of FIG. 14.

The vector control system 202 also includes a Clarke transformation unit 210 coupled to the brushless electric motor 28 that is configured to receive the first phase current Ia and the second phase current Ib and the third phase current Ic from the brushless electric motor 28 and determine and output an alpha stationary reference frame current [symbol] α and a beta stationary reference frame current [symbol] β using a Clarke transformation (e.g., the Clarke transformation will convert the balanced three-phase currents sensed from the 3-axis system of the windings 112a, 112b, 112c, into two-phase quadrature stator currents of a 2-axis coordinate system). A Park transformation unit 212 is coupled to the Clarke transformation unit 210 and is configured to receive the alpha stationary reference frame current [symbol] α and the beta stationary reference frame current [symbol] β and determine and output the torque current drawn [symbol] q and a field flux linkage current drawn ( [symbol] d) using a Park transformation.

A second proportional-integral control unit 214 is coupled to the inverse Park transformation unit 206 and the Park transformation unit 212 and is configured to receive a reference flux linkage current [symbol] d_{ref} and the flux linkage current drawn [symbol] d and determine and output the flux linkage voltage command \hat{V}d to the inverse Park transformation unit 206.

As best shown in FIG. 14, the control system 200 also includes a position determining system 216 (shown at the bottom of FIG. 14) coupled to the vector control system 202 and the brushless electric motor 28. The position determining system 216 is configured to receive the plurality of Hall sensor signals and count a plurality of Hall pulses of the plurality of Hall sensor signals to determine a delta time 224 between each of the plurality Hall pulses. The position determining system 216 is also configured to determine the actual angular velocity of the rotor of the brushless electric motor 28 based on the delta time 224 of a quantity of Hall pulses counted. Using the plurality of Hall sensors 114a, 114b, 114c to determine the position of the rotor 113 is more accurate for ascertaining the position θ compared to more expensive resolvers/encoders. Resolvers are also analog devices susceptible to detecting additional undesirable environmental noise, while encoders are expensive devices.

The position determining system 216 is further configured to determine the actual angular position θ of the rotor 113 of the brushless electric motor 28 based on an angular position offset 218 corresponding to the delta time 224 between each of the plurality Hall pulses and added to a sector angle 220 of one of the plurality of Hall sensors 114a, 114b, 114c from which one of the plurality of Hall pulses was last received. More specifically, the position determining system 216 includes a pulse counter unit 222 configured to receive the plurality of Hall sensor signals and count the plurality of the Hall pulses of the plurality of Hall sensor signals to determine the delta time 224 between each of the plurality Hall pulses and output the quantity of Hall pulses counted 226 and the delta time 224. The position determining system 216 also includes a velocity conversion unit 228 having a timer delta input 230 and configured to receive the delta time 224 and determine the actual angular velocity ω of the rotor 113 of the brushless electric motor 28 based on the delta time 224 of a quantity of Hall pulses counted 226. The position determining system 216 further includes a filter unit 232 configured to filter the actual angular velocity ω.

The position determining system 216 further includes a multiplier unit 234 having a first multiplier input 236 being the delta time 224 and a second multiplier input 238 being the actual angular velocity ω and a multiplier output 240. The multiplier unit 234 is configured to multiply the delta time 224 and the actual angular velocity ω and output the angular position offset 218 at the multiplier output 240.

The position determining system 216 additionally includes a Hall sector determination unit 242 configured to receive the plurality of Hall sensor signals and determine and output the one of a plurality of Hall sectors (shown in FIG. 6) in which the rotor 113 of the brushless electric motor 28 is currently located based on the one of the plurality of Hall pulses last received. The position determining system 216 also includes a base angle unit 244 configured to receive the one of the plurality of Hall sectors and output the sector angle 220 corresponding to the one of the plurality of Hall sectors in which the rotor 113 of the brushless electric motor 28 is currently located. In addition, the position determining system 216 includes an adder unit 246 having a first adder input 248 being sector angle and a second adder input 250 being the angular position offset 218 and an adder output 252 and configured to add the sector angle 220 and the angular position offset 218 and output the actual angular position θ of the rotor 113 of the brushless electric motor 28 at the adder output 252.

The control system 200 also includes a third proportional-integral control unit 254 that generates the target torque current \check{I}q based on the actual angular velocity ω and a target angular velocity 256 (based on a commanded speed or position of the motor 28 to move the power actuator unit 10 as desired) to return the motor 28 back to the target angular velocity 256.

Referring back to the vector control system 202, the Clarke transformation unit 210 has a first phase current input 258 and a second phase current input 260 and a third phase current input 262 each coupled to the brushless electric motor 28 for receiving the first phase current Ia and the second phase current Ib and the third phase current Ic and an alpha stationary reference frame current output 264 coupled to the Park transformation unit 212 for outputting the alpha stationary reference frame current [symbol] α and a beta stationary reference frame current output 266 coupled to the Park transformation unit 212 for outputting the beta stationary reference frame current [symbol] β.

The Park transformation unit 212 has an alpha stationary reference frame current input 268 coupled to the alpha stationary reference frame current output 264 of the Clarke transformation unit 210 for receiving the alpha stationary reference frame current [symbol] α and a beta stationary reference frame current input 270 coupled to the beta stationary reference frame current output 266 of the Clarke transformation unit 210 for receiving the beta stationary reference frame current [symbol] β. The Park transformation unit 212 also has a torque current drawn output 272 coupled to the first proportional-integral control unit 204 for outputting the torque current drawn [symbol] q and a field flux linkage current drawn output 274 coupled to the second proportional-integral control unit 214 for outputting the field flux current drawn [symbol] d.

The second proportional-integral control unit 214 has a second reference input 276 being the reference flux linkage current [symbol] d_{reference} (e.g., reference flux linkage current=0 for reasons as described herein above to eliminate the force acting on the rotor 113 depicted by arrow 159) and a second measured input 278 coupled to the flux linkage current drawn output 274 of the Park transformation unit 212 for receiving the flux linkage current drawn [symbol] d and a flux linkage voltage output 280 coupled to the inverse Park transformation unit 206 for outputting the flux linkage voltage command \hat{V}d.

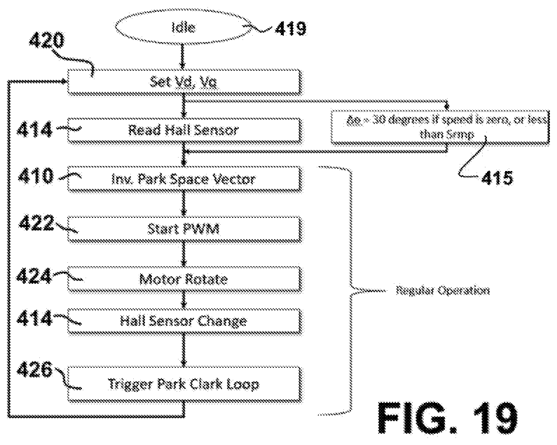

The first proportional-integral control unit 204 has a first reference input 282 coupled to the third proportional-integral control unit 254 for receiving the target torque current \check{I}q. The first proportional-integral control unit 204 also has a first measured input 284 coupled to the torque current drawn output 272 for receiving the torque current drawn [symbol] q and a torque voltage output 286 coupled to the inverse Park transformation unit 206 for outputting the torque voltage command Vq. It is hereby recognized that control system 200 takes advantage of the inherent properties of the brushless electric motor 28, specifically the property that when the brushless electric motor 28 is slowed, for example by a pinch event, the torque current drawn ( [symbol] q) will increase. The PI integration of the difference between the limited torque current (\check{I}q) and this inherently increased torque current drawn ( [symbol] q) as represented in FIG. 15 by arrow F will result in a lowered torque voltage command (\hat{V}q) to be applied to the motor 28, thus further reducing measured angular velocity ω and inertia in the power actuator unit 10.

The inverse Park transformation unit 206 has a first inverse Park input 288 coupled to the torque voltage output 286 of the first proportional-integral control unit 204 for receiving the torque voltage command (\hat{V}q). The inverse Park transformation unit 206 additionally has a second inverse Park input 290 coupled to the flux linkage voltage output 280 of the second proportional-integral control unit 214 for receiving the flux linkage voltage command (\hat{V}d) and a third inverse Park input 292 coupled to the adder output 252 of the adder unit 246 of the position determining system 216 for receiving the actual angular position θ. The inverse Park transformation unit 206 also has an alpha stationary reference frame voltage output 294 coupled to the switching states vector pulse width modulation unit 208 for outputting the alpha stationary reference frame voltage \hat{V}α and a beta stationary reference frame voltage output 296 coupled to the switching states vector pulse width modulation unit 208 for outputting the alpha stationary reference frame voltage \hat{V}β.

The switching states vector (or space vector) pulse width modulation unit 208 converts the two component alpha stationary reference frame voltage \hat{V}α and the beta stationary reference frame voltage \hat{V}β into the three component stator domain to generate the PWM signals to be supplied to each stator winding 112a, 112b, 112c. The switching states vector pulse width modulation unit 208 has an alpha stationary reference frame voltage input 298 coupled to the alpha stationary reference frame voltage output 294 of the inverse Park transformation unit 206 for receiving the alpha stationary reference frame voltage \hat{V}α and a beta stationary reference frame voltage input 300 coupled to the beta stationary reference frame voltage output 296 of the inverse Park transformation unit 206 for receiving the beta stationary reference frame voltage \hat{V}β. The switching states vector pulse width modulation unit 208 also has a first phase pulse width modulation output 302 coupled to the brushless electric motor 28 (e.g., to winding 112a) for outputting the first phase pulse modulation signal PWMa and a second phase pulse width modulation output 304 coupled to the brushless electric motor 28 (e.g. to winding 112b) for outputting the second phase pulse modulation signal PWMb and a third phase pulse width modulation output 306 coupled to the brushless electric motor 28 (e.g. to winding 112c) for outputting the third phase pulse width modulation signal PWMc.

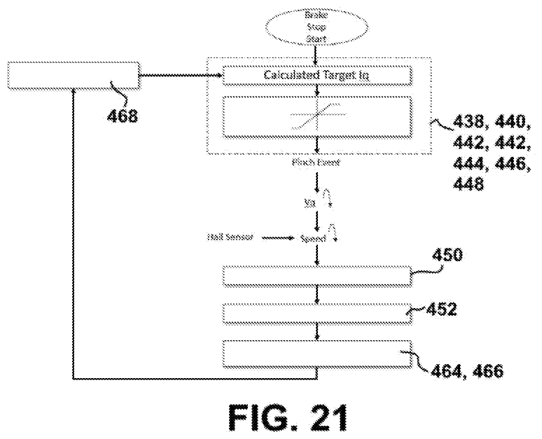

As best shown in FIGS. 17-21, a method of controlling a brushless electric motor 28 using a control system 200 including a vector control system 202 and a position determining system 216. The method includes the step of 400 sampling a first phase current Ia and a second phase current Ib and a third phase current Ic from the brushless electric motor 28 using the vector control system 202. The method continues with the step of 402 receiving a plurality of Hall sensor signals from a plurality of Hall sensors 114a, 114b, 114c sensing a position θ of a rotor 113 of the brushless electric motor 28 using the position determining system 216. The method also includes the step of 404 determining an estimated position of the rotor 113 of the brushless electric motor 28 based on an angular position offset 218 corresponding to the delta time 224 between each of the plurality Hall pulses and added to a sector angle 220 of one of the plurality of Hall sensors 114a, 114b, 114c from which one of the plurality of Hall pulses was last received. Three hall sensors are illustratively shown, but other numbers of hall sensors may be provided for alternative configurations, for example at least one Hall sensor. The method begins at idle 419.

The method also includes the step of 406 determining whether the rotor 113 of the brushless electric motor 28 is stopped or rotating at less than a predetermined angular velocity based on the plurality of Hall sensor signals. Next, the method includes 408 assuming a position of the rotor 113 being at an assumed position in response to the rotor 113 of the brushless electric motor 28 being stopped or rotating at less than a predetermined angular velocity. The method also includes 410 updating the stored torque voltage command based on the assumed position and a plurality of predetermined application specific system parameters to minimize stresses on the brushless electric motor 28 and provide a maximized torque force. In more detail, the step of 410 updating the stored torque voltage command based on the assumed position and the plurality of predetermined application specific system parameters includes the step of 412 calculating the stored torque voltage command as Vq=cosine(((360/(HSQ*2))/2)*Vq, where Vq is the stored torque voltage command and HSQ is a quantity of the plurality of Hall sensors 114a, 114b, 114c. In more detail, there is a Hall sensor position blind spot (unknown exact rotor position) during start up or stall during pinch can be estimated to provide 86% (e.g., cosine (30 degrees), the assumed midpoint between each hall sensor sector) of the maximum startup application specific torque to provide the most likely maximized torque for quick start up (e.g., to maximize torque even when the rotor position is unknown based on using the Hall sensors), placing less stress on components, and improving component life for applications with frequent start and stops.

The next step of the method is 414 determining whether an edge of a plurality of Hall sensor signals is detected. The step of 414 determining whether an edge of a plurality of Hall sensor signals is detected can include the step of 416 determining whether an edge of a plurality of Hall sensor signals is detected in response to calculating the torque voltage command Vq based on the assumed position and the plurality of predetermined application specific system parameters. The step of 414 determining whether an edge of a plurality of Hall sensor signals is detected can also be defined as 418 determining whether the edge of a plurality of Hall sensor signals is detected in response to the rotor 113 of the brushless electric motor 28 not being stopped and not rotating at less than a predetermined speed. A step of 415 determining whether an edge of a plurality of Hall sensor signals is not detected can also be defined as 418 determining whether the edge of a plurality of Hall sensor signals is not detected in response to the rotor 113 of the brushless electric motor 28 being stopped or rotating at less than a predetermined speed e.g. 5 rpm and setting a rotor position θ of the rotor 113 at a predefined position, such as at 30 degrees.

The method then includes the step of 420 setting a stored flux linkage voltage command and one of a stored torque voltage command and a stored start-up calculated torque voltage command with the vector control system 202 in response to determining the edge of the plurality of Hall sensor signals is not detected. The method proceeds by 422 outputting a first phase pulse width modulation signal PWMa and a second phase pulse width modulation signal PWMb and a third phase pulse width modulation signal PWMc to the brushless electric motor 28 using a switching states vector pulse width modulation unit 208 using the stored flux linkage voltage command and the stored torque voltage command updated based on the position θ of the rotor 113 of the brushless electric motor 28. The method continues with the step of 424 rotating the brushless electric motor 28 due to the first phase pulse width modulation signal PWMa and the second phase pulse width modulation signal PWMb and the third phase pulse width modulation signal PWMc.

The method also includes the step of 426 updating the stored flux linkage voltage command and the stored torque voltage command with the vector control system 202 based on sampling the first phase current Ia and the second phase current Ib and the third phase current Ic in response to determining a subsequent edge of the plurality of Hall sensor signals is detected. The step of 426 updating the flux linkage voltage command and the stored torque voltage command may include 428 entering a first interrupt subroutine, based on an Interrupt on Change (IOC) to specify to the microcontroller 133 whether the interrupt should be triggered by a rising edge or by a falling edge of the Hall sensor signals, to update and store the stored flux linkage voltage command and the stored torque voltage command using the vector control system 202 in response to determining the edge of the plurality of Hall sensor signals is detected. Then, the method continues by 430 returning to the step of 400 sampling the first phase current Ia and the second phase current Ib and the third phase current Ic from the brushless electric motor 28. The method proceeds by 432 updating the stored flux linkage voltage command and the stored torque voltage command using the sampled the first phase current Ia and the second phase current Ib and the third phase current Ic.

Steps 410, 422, 424, 414, and 426 as viewed in FIG. 19 may be steps part of a regular control operation.

In more detail, as shown in FIG. 18, the step of 428 entering the first interrupt subroutine to obtain and store the stored flux linkage voltage command and the stored torque voltage command using the vector control system 202 to minimize a field flux linkage current Id and maximize a torque current Iq in response to determining the edge of the plurality of Hall sensor signals is detected can include the step of 434 calculating the stored flux linkage voltage command and the stored torque voltage command using the vector control system 202 based on the position θ of the rotor 113 when the edge of the plurality of Hall sensor signals is detected to minimize a field flux linkage current Id and maximize the torque current Iq. Next, 436 updating the stored flux linkage voltage command and the stored torque voltage command in a memory 138 to be used by the switching states vector pulse width modulation unit 208.

As best shown in FIGS. 20 and 21, the method can additionally include the steps of 438 determining a torque current based on the first phase current Ia and the second phase current Ib and the third phase current Ic from the brushless electric motor 28 using the vector control system 202. Then, the method can also include the step of 440 determining an actual angular velocity ω of the rotor 113 of the brushless electric motor 28 based on the plurality of Hall sensor signals using a position determining system 216. More specifically, the step of determining the actual angular velocity ω of the rotor 113 of the brushless electric motor 28 based on the plurality of Hall sensor signals using the position determining system 216 can include the steps of 442 receiving the plurality of Hall sensor signals using the position determining system 216 and counting the plurality of Hall pulses of the plurality of Hall sensor signals and 444 determining a delta time 224 between each of the plurality Hall pulses.

The method can continue by 446 determining the actual angular velocity ω of the rotor 113 of the brushless electric motor 28 based on the delta time 224 of a quantity of Hall pulses counted. The method can also include 448 determining whether the torque current Iq is increasing and the actual angular velocity ω of the rotor 113 of the brushless electric motor 28 is decreasing and 450 determining there is a pinch event in response to the torque current Iq increasing and the actual angular velocity ω of the rotor 113 of the brushless electric motor 28 decreasing. The method can also include the step of 452 setting a reverse speed in response to determining there is the pinch event.

The method can also include the step of 454 determining whether the edge of a plurality of Hall sensor signals is detected. The method continues by 456 assuming the position θ of the rotor 113 being at an assumed position in response to determining the edge of the plurality of Hall sensor signals is not detected and 458 updating the stored torque voltage command based on the assumed position as a negative stored torque voltage command. Specifically, the step of 458 updating the stored torque voltage command based on the assumed position as a negative stored torque voltage command includes the step of 460 calculating the negative stored torque voltage command as Vq=−cosine(((360/(HSQ*2))/2)*Vq, where Vq is the stored torque voltage command and HSQ is a quantity of the plurality of Hall sensors 114a, 114b, 114c. An optimal torque can therefore be applied in a pinch detection event when the exact position of the rotor 113 is between hall sensors trigger points P1-P6.

The next step of the method is 462 outputting the first phase pulse width modulation signal PWMa and the second phase pulse width modulation signal PWMb and the third phase pulse width modulation signal PWMc to the brushless electric motor 28 using the switching states vector pulse width modulation unit 208 using the negative stored flux linkage voltage command and the stored torque voltage command updated based on the position θ of the rotor 113 of the brushless electric motor 28. In more detail, the step of 462 outputting the first phase pulse width modulation signal PWMa and the second phase pulse width modulation signal PWMb and the third phase pulse width modulation signal PWMc to the brushless electric motor 28 using the switching states vector pulse width modulation unit 208 using the stored flux linkage voltage command and the negative stored torque voltage command updated based on the position θ of the rotor 113 of the brushless electric motor 28 includes the step of 464 triggering a Clarke transformation unit 210 to determine and output an alpha stationary reference frame current [symbol] α and a beta stationary reference frame current [symbol] β using a Clarke transformation based on the first phase current Ia and the second phase current Ib and the third phase current Ic from the brushless electric motor 28. The method continues by 466 triggering a Park transformation unit 212 coupled to the Clarke transformation unit 210 to determine and output the torque current drawn and a field flux linkage current drawn using a Park transformation based on the alpha stationary reference frame current [symbol] α and the beta stationary reference frame current [symbol] β. The method can also include the step of 468 triggering an inverse Park transformation unit 206 coupled to a first proportional-integral control unit 204 to transform the torque voltage command and the flux linkage voltage command to the alpha stationary reference frame voltage \hat{V}α and the beta stationary reference frame voltage \hat{V}β using an inverse Park transformation based on an actual angular position θ of the brushless electric motor 28.

The next step of the method is 470 rotating the brushless electric motor 28 due to the first phase pulse width modulation signal PWMa and the second phase pulse width modulation signal PWMb and the third phase pulse width modulation signal PWMc. The method proceeds with the step of 472 entering a second interrupt subroutine to update and store the stored flux linkage voltage command and the negative stored torque voltage command using the vector control system 202 in response to determining the edge of the plurality of Hall sensor signals is detected. Since the exact position of the rotor 113 is known in response to detecting the hall signal edge, the maximal torque, such as Iq, can be applied to reverse the rotor 113. The next step of the method is 474 returning to the step of 400 sampling the first phase current Ia and the second phase current Ib and the third phase current Ic from the brushless electric motor 28 in response to outputting the first phase pulse width modulation signal PWMa and the second phase pulse width modulation signal PWMb and the third phase pulse width modulation signal PWMc to the brushless electric motor 28 using the switching states vector pulse width modulation unit 208.

The control system 200 disclosed herein provides numerous advantages. In brushed motors where a bus voltage is used to control the brushed motor, torque and speed are mixed into the bus voltage. Separate control of these parameters can provide more precise correlation to the input motor voltage and the output motor position. Field oriented control provides faster dynamic response than for applications with a brushed motor. The control system 200 and associated method improves efficiency and response without requiring position estimation calculations and expensive position detectors such as resolvers. In fact, the present uses low cost Hall sensors 114a, 114b, 114c with digital signals (e.g., rising edge, falling edge) for precise position of the rotor 113 for calculating the FOC torque vector, using less frequent flux linkage voltage command Vd and torque voltage command Vq calculations. Additionally, since vector control allows for more precise control of the brushless electric motor 28, the disclosed method also allows for maximum torque for motor reversal during a pinch event for position detected using the Hall sensors 114a, 114b, 114c.

In other systems, feedback is based on speed differences between actual motor speed and a target motor speed. So, if there is a drop in motor speed, the voltage applied to the motor will be increased by the control system to increase the motor speed. In such control systems, maintaining operating speed is the concern, and not anti-pinch concerns, such as in brushless motor control for fans and pumps. While Hall sensors can be used to calculate and estimate motor speed and position, resolvers are instead used for more accurate position of the rotor. However, resolvers are expensive, require retrofitting to the motor shaft, and are susceptible to noise as they output an analog signal compared to the hall sensors digital signal. Thus, the torque vector is continuously calculated based on the position of the rotor, for example thousands of times per revolution of the rotor, thereby requiring increased computational power. (e.g., a more expensive and powerful microprocessor). Also the resolvers have a low signal to noise ratio which requires additional signal filtering and processing and can result in incorrect position readings of the rotor, leading to the incorrect calculation of the FOC torque vector (flux linkage voltage command Vd and torque voltage command Vq).

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As discussed above, the control system 200 disclosed herein can be applied to window regulators for improving response times for anti-pinch by providing more accurate torque voltage command Vq values for the exact rotor position. Other motor applications are also contemplated. Those skilled in the art will recognize that concepts disclosed in association with the example control system can likewise be implemented into many other systems to control one or more operations and/or functions, such as, but not limited to the obstacle detection functionality of the motor of a spindle for a power lift gate system for detecting obstacle/pinches during opening closing of the liftgate, latch systems such as the reducing the component strengths of latch system now subjected to less loading due to a precise torque control of the motor, or a side door power actuator of a vehicle employing obstacle detection.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A control system for controlling a brushless electric motor of a power operated actuator, the brushless electric motor having a rotor and at least one Hall sensor for sensing a position of the rotor, comprising:
a vector control system coupled to the brushless electric motor and configured to:
calculate a quadrature current component and a flux current component in response to the at least one Hall sensor sensing a position of the rotor of the brushless electric motor, and
control a pulse width modulation signal supplied to the brushless electric motor based on the quadrature current component and the flux current component.

2. The control system as set forth in claim 1, the vector control system configured to:
receive an estimated position θ of a rotor of the brushless electric motor and a target torque current \check{I}q based on an actual angular velocity ω of the rotor of the brushless electric motor,
determine an alpha stationary reference frame voltage \hat{V}α and a beta stationary reference frame voltage \hat{V}β based on the target torque current \check{I}q and a first phase current Ia and a second phase current Ib and a third phase current Ic from the brushless electric motor in response to a Hall sensor trigger based on a plurality of Hall sensor signals from a plurality of Hall sensors sensing a position of the rotor of the brushless electric motor,
maintain the alpha stationary reference frame voltage \hat{V}α and a beta stationary reference frame voltage \hat{V}β; and
output a first phase pulse width modulation signal PWMa and a second phase pulse width modulation signal PWMb and a third phase pulse width modulation signal PWMc to the brushless electric motor based on the alpha stationary reference frame voltage \hat{V}α and the beta stationary reference frame voltage \hat{V}p.

3. The control system as set forth in claim 2, wherein the alpha stationary reference frame voltage \hat{V}α and the beta stationary reference frame voltage \hat{V}β is maintained until a subsequent Hall sensor trigger, and, wherein the alpha stationary reference frame voltage \hat{V}α and the beta stationary reference frame voltage \hat{V}β is maintained as a function of an estimated position θ of the rotor.

4. The control system as set forth in claim 2, further comprising a position determining system coupled to the vector control system and the brushless electric motor and configured to:
receive the plurality of Hall sensor signals,
count a plurality of Hall pulses of the plurality of Hall sensor signals and determine a delta time between each of the plurality Hall pulses, and
determine the actual angular velocity ω of the rotor of the brushless electric motor based on the delta time of a quantity of Hall pulses counted.

5. The control system as set forth in claim 4, wherein the position determining system is further configured to determine the estimated position θ of the rotor of the brushless electric motor based on an angular position offset corresponding to the delta time between each of the plurality Hall pulses and added to a sector angle of one of the plurality of Hall sensors from which one of the plurality of Hall pulses was last received.

6. The control system as set forth in claim 4, wherein the position determining system includes:
a pulse counter unit configured to receive the plurality of Hall sensor signals and count the plurality of the Hall pulses of the plurality of Hall sensor signals and determine the delta time between each of the plurality Hall pulses and output the quantity of Hall pulses counted and the delta time; and
a velocity conversion unit having a timer delta input and configured to receive the delta time and determine the actual angular velocity ω of the rotor of the brushless electric motor based on the delta time of the quantity of Hall pulses counted;
wherein the position determining system further includes a filter unit configured to filter the actual angular velocity ω;
wherein the position determining system further includes a multiplier unit having a first multiplier input being the delta time and a second multiplier input being the actual angular velocity ω and a multiplier output and configured to multiply the delta time and the actual angular velocity ω and output an angular position offset at the multiplier output.

7. The control system of claim 5, wherein the position determining system further includes:
a Hall sector determination unit configured to receive the plurality of Hall sensor signals and determine and output the one of a plurality of Hall sectors in which the rotor of the brushless electric motor is currently located based on the one of the plurality of Hall pulses last received;
a base angle unit configured to receive the one of the plurality of Hall sectors and output a sector angle corresponding to the one of the plurality of Hall sectors in which the rotor of the brushless electric motor is currently located; and
an adder unit having a first adder input being sector angle and a second adder input being the angular position offset and an adder output and configured to add the sector angle and the angular position offset and output the estimated position θ of the rotor of the brushless electric motor at the adder output.

8. The control system as set forth in claim 2, wherein the vector control system comprises:
a first proportional-integral control unit configured to receive the target torque current based on the actual angular velocity ω of the brushless electric motor and a torque current drawn and output a torque voltage command Vq and a flux linkage voltage command Vd using the torque current and the torque current drawn;
an inverse Park transformation unit coupled to the first proportional-integral control unit and configured to receive an actual angular position θ of the brushless electric motor and transform the torque voltage command and the flux linkage voltage command to the alpha stationary reference frame voltage and the beta stationary reference frame voltage an inverse Park transformation;
a switching states vector pulse width modulation unit coupled to the inverse Park transformation unit and to the brushless electric motor and configured to determine and output a first phase pulse width modulation signal PWMa and a second phase pulse width modulation signal PWMb and a third phase pulse width modulation signal PWMc to the brushless electric motor;
a Clarke transformation unit coupled to the brushless electric motor and configured to receive the first phase current Ia and the second phase current Ib and the third phase current Ic from the brushless electric motor and determine and output an alpha stationary reference frame current and a beta stationary reference frame current using a Clarke transformation;
a Park transformation unit coupled to the Clarke transformation unit and configured to receive the alpha stationary reference frame current and the beta stationary reference frame current and determine and output the torque current drawn and a field flux linkage current drawn using a Park transformation; and
a second proportional-integral control unit coupled to the inverse Park transformation unit and the Park transformation unit and configured to receive a reference flux linkage current and the flux linkage current drawn and determine and output the flux linkage voltage command to the inverse Park transformation unit.

9. A method of controlling a brushless electric motor using a control system including a vector control system and a position determining system, comprising the steps of:
calculating a quadrature current component and a flux current component in response to the position determining system sensing a position of the rotor of the brushless electric motor, and
controlling a pulse width modulation signal supplied to the brushless electric motor based on the quadrature current component and the flux current component.

10. The method as set forth in claim 9, comprising the steps of:
sampling a first phase current Ia and a second phase current Ib and a third phase current Ic from the brushless electric motor using the vector control system;
receiving a plurality of Hall sensor signals from a plurality of Hall sensors sensing a position of a rotor of the brushless electric motor using the position determining system;
determining whether an edge of a plurality of Hall sensor signals is detected;
setting a stored flux linkage voltage command and one of a stored torque voltage command and a stored start-up calculated torque voltage command with the vector control system in response to determining the edge of the plurality of Hall sensor signals is not detected;
outputting a first phase pulse width modulation signal PWMa and a second phase pulse width modulation signal PWMb and a third phase pulse width modulation signal PWMc to the brushless electric motor using a switching states vector pulse width modulation unit using the stored flux linkage voltage command and the stored torque voltage command updated based on the position θ of the rotor of the brushless electric motor; and
rotating the brushless electric motor due to the first phase pulse width modulation signal PWMa and the second phase pulse width modulation signal PWMb and the third phase pulse width modulation signal PWMc.

11. The method as set forth in claim 10, further including the step of updating the stored flux linkage voltage command and the stored torque voltage command with the vector control system based on sampling the first phase current Ia and the second phase current Ib and the third phase current Ic in response to determining a subsequent edge of the plurality of Hall sensor signals is detected.

12. The method as set forth in claim 11, wherein the step of updating the flux linkage voltage command and the stored torque voltage command includes entering a first interrupt subroutine to update and store the stored flux linkage voltage command and the stored torque voltage command using the vector control system in response to determining the edge of the plurality of Hall sensor signals is detected;
returning to the step of sampling the first phase current Ia and the second phase current Ib and the third phase current Ic from the brushless electric motor; and
updating the stored flux linkage voltage command and the stored torque voltage command using the sampled the first phase current Ia and the second phase current Ib and the third phase current Ic.

13. The method as set forth in claim 10, further including the steps of:
determining whether the rotor of the brushless electric motor is stopped or rotating at less than a predetermined angular velocity based on the plurality of Hall sensor signals;
assuming a position of the rotor being at an assumed position in response to the rotor of the brushless electric motor being stopped or rotating at less than a predetermined angular velocity; and
updating the stored torque voltage command based on the assumed position and a plurality of predetermined application specific system parameters to minimize stresses on the brushless electric motor and provide a maximized torque force; and,
wherein the step of updating the stored torque voltage command based on the assumed position and the plurality of predetermined application specific system parameters includes the step of calculating the stored torque voltage command as:
Vq=cosine(((360/(HSQ*2))/2)*Vq, wherein Vq is the stored torque voltage command and HSQ is a quantity of the plurality of Hall sensors; and,
wherein the step of determining whether an edge of a plurality of Hall sensor signals is detected includes the step of determining whether an edge of a plurality of Hall sensor signals is detected in response to calculating the torque voltage command based on the assumed position and the plurality of predetermined application specific system parameters.

14. The method as set forth in claim 10, wherein the step of determining whether an edge of a plurality of Hall sensor signals is detected is further defined as determining whether the edge of a plurality of Hall sensor signals is detected in response to the rotor of the brushless electric motor not being stopped and not rotating at less than a predetermined speed.

15. The method as set forth in claim 12, wherein the step of entering the first interrupt subroutine to obtain and store the stored flux linkage voltage command and the stored torque voltage command using the vector control system to minimize a field flux linkage current and maximize a torque current in response to determining the edge of the plurality of Hall sensor signals is detected includes:
calculating the stored flux linkage voltage command and the stored torque voltage command using the vector control system based on the position of the rotor when the edge of the plurality of Hall sensor signals is detected to minimize a field flux linkage current and maximize the torque current; and
updating the stored flux linkage voltage command and the stored torque voltage command in a memory to be used by the switching states vector pulse width modulation unit.

16. The method as set forth in claim 10, further including the steps of:
determining a torque current based on the first phase current Ia and the second phase current Ib and the third phase current Ic from the brushless electric motor using the vector control system;
determining an actual angular velocity ω of the rotor of the brushless electric motor based on the plurality of Hall sensor signals using a position determining system;
determining whether the torque current is increasing and the actual angular velocity ω of the rotor of the brushless electric motor is decreasing; and
determining there is a pinch event in response to the torque current increasing and the actual angular velocity ω of the rotor of the brushless electric motor decreasing.

17. The method as set forth in claim 16, wherein the step of determining the actual angular velocity of the rotor of the brushless electric motor based on the plurality of Hall sensor signals using the position determining system includes the steps of:
receiving the plurality of Hall sensor signals using the position determining system;
counting the plurality of Hall pulses of the plurality of Hall sensor signals and determining a delta time between each of the plurality Hall pulses; and
determining the actual angular velocity ω of the rotor of the brushless electric motor based on the delta time of a quantity of Hall pulses counted; and,
further including the step of determining an actual angular position θ of the rotor of the brushless electric motor based on an angular position offset corresponding to the delta time between each of the plurality Hall pulses and added to a sector angle of one of the plurality of Hall sensors from which one of the plurality of Hall pulses was last received.

18. The method as set forth in claim 16, further including the steps of:
determining whether the edge of a plurality of Hall sensor signals is detected;
assuming the position of the rotor being at an assumed position in response to determining the edge of the plurality of Hall sensor signals is not detected; and
updating the stored torque voltage command based on the assumed position as a negative stored torque voltage command;
outputting the first phase pulse width modulation signal PWMa and the second phase pulse width modulation signal PWMb and the third phase pulse width modulation signal PWMc to the brushless electric motor using the switching states vector pulse width modulation unit using the negative stored flux linkage voltage command and the stored torque voltage command updated based on the position θ of the rotor of the brushless electric motor;
rotating the brushless electric motor due to the first phase pulse width modulation signal PWMa and the second phase pulse width modulation signal PWMb and the third phase pulse width modulation signal PWMc;
entering a second interrupt subroutine to update and store the stored flux linkage voltage command and the negative stored torque voltage command using the vector control system in response to determining the edge of the plurality of Hall sensor signals is detected; and
returning to the step of sampling the first phase current Ia and the second phase current Ib and the third phase current Ic from the brushless electric motor (28) in response to outputting the first phase pulse width modulation signal PWMa and the second phase pulse width modulation signal PWMb and the third phase pulse width modulation signal PWMc to the brushless electric motor using the switching states vector pulse width modulation unit.

19. The method as set forth in claim 18, wherein the step of updating the stored torque voltage command based on the assumed position as a negative stored torque voltage command includes the step of calculating the negative stored torque voltage command as:
Vq=−cosine(((360/(HSQ*2))/2)*Vq, wherein Vq is the stored torque voltage command and HSQ is a quantity of the plurality of Hall sensors.

20. The method as set forth in claim 18, further including the step of setting a reverse speed in response to determining there is the pinch event.

21. The method as set forth in claim 18, wherein the step of outputting the first phase pulse width modulation signal PWMa and the second phase pulse width modulation signal PWMb and the third phase pulse width modulation signal PWMc to the brushless electric motor using the switching states vector pulse width modulation unit using the stored flux linkage voltage command and the negative stored torque voltage command updated based on the position θ of the rotor of the brushless electric motor includes the steps of:
triggering a Clarke transformation unit to determine and output an alpha stationary reference frame current and a beta stationary reference frame current using a Clarke transformation based on the first phase current Ia and the second phase current Ib and the third phase current Ic from the brushless electric motor; and
triggering a Park transformation unit coupled to the Clarke transformation unit to determine and output the torque current drawn and a field flux linkage current drawn using a Park transformation based on the alpha stationary reference frame current and the beta stationary reference frame current.

22. The method as set forth in claim 18, further including the step of triggering an inverse Park transformation unit coupled to a first proportional-integral control unit to transform the torque voltage command and the flux linkage voltage command to the alpha stationary reference frame voltage and the beta stationary reference frame voltage using an inverse Park transformation based on an actual angular position θ of the brushless electric motor.
